(19) United States
(12) Patent Application Publication
(10) Pub. No.: US 2011/0171422 A1
(43) Pub. Date: Jul. 14, 2011

(54) HYDROPHOBIC LAYER FOR FOAM TAPE SYSTEM

(76) Inventor: Ben Meaige, Dublin, OH (US)

(21) Appl. No.: 12/686,655

(22) Filed: Jan. 13, 2010

(51) Int. Cl. C09J 7/00; C09J 5/08; C09K 3/00; B05D 5/08; B05D 1/18

(52) U.S. Cl. 428/119; 427/209; 427/384; 427/430.1

(57) ABSTRACT

Some embodiments relate to moisture resistant foam tapes including one or more pressure sensitive adhesive layers. Furthermore, according to some embodiments, a hydrophobic moisture barrier is applied to one or more sides of an adhesive tape member to protect the tape member and/or adhesive layer(s) from moisture, such as atmospheric moisture or liquid water.

### I. BACKGROUND OF THE INVENTION

A. Field of Invention

This invention generally relates to moisture resistant foam tapes for pressure sensitive adhesive tape applications.

B. Description of the Related Art

It is known in the art to have double sided pressure sensitive adhesive tape. It is also known in the art to have such tapes that include a foamed polymer tape member defining a flexible sheet structure. However, such tapes that are known in the art have certain disadvantages. More specifically, such tapes tend to degrade in the presence of moisture. Still more specifically, pressure sensitive adhesives generally include hydrophilic components which may tend to absorb moisture, such as atmospheric moisture or liquid water. What is needed is a double sided pressure sensitive adhesive tape that includes one or more structures for protecting the tape from moisture.

Some embodiments of the present invention may over come one or more shortcomings of the prior art.

### II. SUMMARY OF THE INVENTION

Some embodiments relate to a moisture resistant tape system, comprising: a tape member comprising a flexible sheet having a first major surface and a second major surface generally parallel to the first major surface, the first major surface and second major surface being spaced apart, the space bounded by a first minor surface and a second minor surface adjoining the first and second major surfaces, and the tape member further comprising a foamed polymer composition; and a side layer comprising a hydrophobic moisture barrier fixedly disposed on the first minor surface of the tape member. The moisture resistant tape system may include a second side layer comprising a hydrophobic moisture barrier fixedly disposed on the second minor surface of the tape member. The moisture resistant tape system may include at least a first adhesive layer adhesively disposed on a major surface of the tape member. The moisture resistant tape system may include a first adhesive layer adhesively disposed on the first major surface and a second adhesive layer adhesively disposed on the second major surface of the tape member. The moisture resistant tape system may include one or more side layers comprising a hydrophobic organic polymer selected from one or more of polyfluoroethylene, polytetrafluoroethylene, polyperfluoroolefin, polyethylene, and polyolefin.

Some embodiments relate to a moisture resistant tape system, comprising: a tape member comprising a flexible sheet having a first major surface and a second major surface generally parallel to the first major surface, the first major surface and second major surface being spaced apart, the space bounded by a first minor surface and a second minor surface adjoining the first and second major surfaces, and the tape member further comprising a foamed polymer composition; and a pair of opposing side layers comprising hydrophobic moisture barriers fixedly disposed on the first and second minor surfaces of the tape member.

Some embodiments relate to a process for producing side-coated tape, comprising the steps of: providing a roll of an adhesive foam tape, the roll defining a first side comprising a first minor face of a tape member arranged in a spiral configuration, and a second side comprising a second minor face of a tape member arranged in a spiral configuration; applying a first moisture barrier to the first side of the roll, wherein the first moisture barrier bonds to the first minor face of the tape member, and wherein the first moisture barrier is adapted to allow the tape member to be unrolled while the first moisture barrier remains functionally bonded to the first minor face. The process for producing side-coated tape may include the step of applying a second moisture barrier to the second side of the roll, wherein the second moisture barrier bonds to the second minor face of the tape member, and wherein the second moisture barrier is adapted to allow the tape member to be unrolled while the second moisture barrier remains functionally bonded to the second minor face. The steps of applying a moisture barrier to the first side of the roll and/or applying a moisture barrier to a second side of the roll may further comprise applying a monomeric composition to the first and second sides, and then curing the monomeric composition, the polymerized composition defining the functional moisture barrier. The first moisture barrier and/or the second moisture barrier can be independently selected from one or more of polyfluoro olefin, polyfluoroethylene, polytetrafluoroethylene, polyperfluoro olefin, polyethylene, and polyolefin. The steps of applying a first and/or a second moisture barrier to a first and a second side of the roll may comprise dip-coating the tape member in a polymerization reaction solution.

Some embodiments relate to a vehicle comprising: a first vehicle component; and a moisture resistant tape comprising: a tape member comprising a flexible sheet having a first major surface and a second major surface generally parallel to the first major surface, the first major surface and second major surface being spaced apart, the space bounded by a first minor surface and a second minor surface adjoining the first and second major surfaces, and the tape member further comprising a foamed polymer composition; a first side layer comprising a hydrophobic moisture barrier fixedly disposed on the first minor surface of the tape member; and a first adhesive layer adhesively disposed on the first major surface of the tape member; wherein the first adhesive layer fixedly attaches the tape member to the first vehicle component. The moisture resistant tape may include a second side layer comprising a hydrophobic moisture barrier fixedly disposed on the second minor surface of the tape member. The vehicle may include a second vehicle component; wherein the moisture resistant tape further comprises a second adhesive layer adhesively disposed on the second major surface of the tape member; wherein the tape member fixedly attaches the second vehicle component to the first vehicle component.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of an arbitrary length of tape according to an embodiment;

FIG. 2 is a cross sectional view of the tape of FIG. 1, showing adhesive layers;

FIG. 3 is a cross sectional view of the tape of FIG. 1 showing hydrophobic moisture barrier layers;

FIG. 4 is a cross sectional view of the tape of FIG. 1 simultaneously showing the adhesive layers, and the hydrophobic moisture barrier layers;

FIG. 5 is a perspective view of a roll of tape according to an embodiment;

FIG. 6 is a perspective view of the roll of FIG. 5 including a hydrophobic moisture barrier layer; and

FIG. 7 is a perspective view of the tape in use on a vehicle.

### IV. DETAILED DESCRIPTION OF THE INVENTION

According to one embodiment, a foam tape system comprises a tape member including a flexible sheet. The sheet can have a first major surface, and a second major surface oriented generally parallel to the first. The first and second major surfaces can be spaced apart, and the space between them can be bounded by a first minor surface and a second minor surface that adjoin major surfaces. Furthermore, according to some embodiments the tape member comprises a foamed polymer composition, such as an open cell foam or a closed cell foam. The tape member can include an adhesive layer coated on one or both major surfaces. In some embodiments, the first and second minor surfaces include hydrophobic moisture barriers fixedly disposed thereon.

According to some embodiments, suitable foamed polymer compositions can include one or more of polyolefin, polyethylene, polypropylene, polyester, polyamide, nylon, butyl rubber, neoprene, polyfluoro olefin, poly tetrafluoroethylene, perfluoro olefin, or any suitable combination thereof including, without limitation, copolymers or mixtures.

According to some embodiments, suitable adhesives can include any of a wide variety of pressure sensitive adhesives (PSAs) known in the art. Suitable pressure sensitive adhesives can comprise one or more of polyurethane, natural rubber, styrene-butadiene rubber, butyl rubber, butadiene-acrylonitrile rubber polyvinyl ether rubber, polyacrylate ester rubber, styrene-butadiene-styrene rubber, styrene-isoprene-styrene rubber, silicones, acrylic rubber, vinyl alkyl ether, polyvinylpyrrolidone, polyacrylamide, cellulose, or any suitable combination thereof including, without limitation, copolymers or mixtures.

According to some embodiments, suitable hydrophobic moisture barriers can include any of a wide range of suitable hydrophobic polymers known in the art. For instance, some suitable hydrophobic moisture barriers can comprise one or more of polyethylene, polyfluoro olefin, polyfluoroethylene, polytetrafluoroethylene, polyperfluoro olefin, or polyolefin. Furthermore, in some embodiments, the hydrophobic moisture barrier can be bonded to one or more minor sides of the tape member. Suitable bonds can include, without limitation, one or more of covalent, ionic, electrostatic, or dispersion force bonds. Still other suitable bonds can include, without limitation, mechanical interpenetration of the moisture barrier material and the tape member material.

In some embodiments the hydrophobic moisture barrier can be applied to the minor side or sides of the tape member in a pre-made polymeric form, and bonded thereto by a suitable means known in the art. Alternatively, the hydrophobic moisture barrier can be formed on the minor side or sides of the tape member by polymerizing a suitable chemical solution thereon. According to some embodiments, a hydrophobic material is dip-coated onto the minor side or sides of the tape member. Any method of dip coating chosen with ordinary skill in the art can be used. According to some embodiments, the hydrophobic is synthesized in such a way that the amount of branching is increased and the density is lowered in order to soften the final polymer product, while not affecting the hydrophobicity of the product. According to these embodiments, the molecular weight is lowered so that the coating fails cohesively on itself as the roll of tape is torn, while adhering cohesively to the roll of tape and maintaining its coating function. According to some embodiments, the molecular weight can be advantageously controlled through catalyst ratio, flow rate, and/or other processing methods. According to some embodiments, molecular weight of the hydrophobic material can be advantageously controlled through solvent selection and through controlling polymer branching. Control over molecular weight and branching enables control over adhesion force. One of skill in the art will recognize that when the adhesive force between the hydrophobic layer and the tape member is larger than the cohesive force of the hydrophobic material, the hydrophobic material will tend not to delaminate.

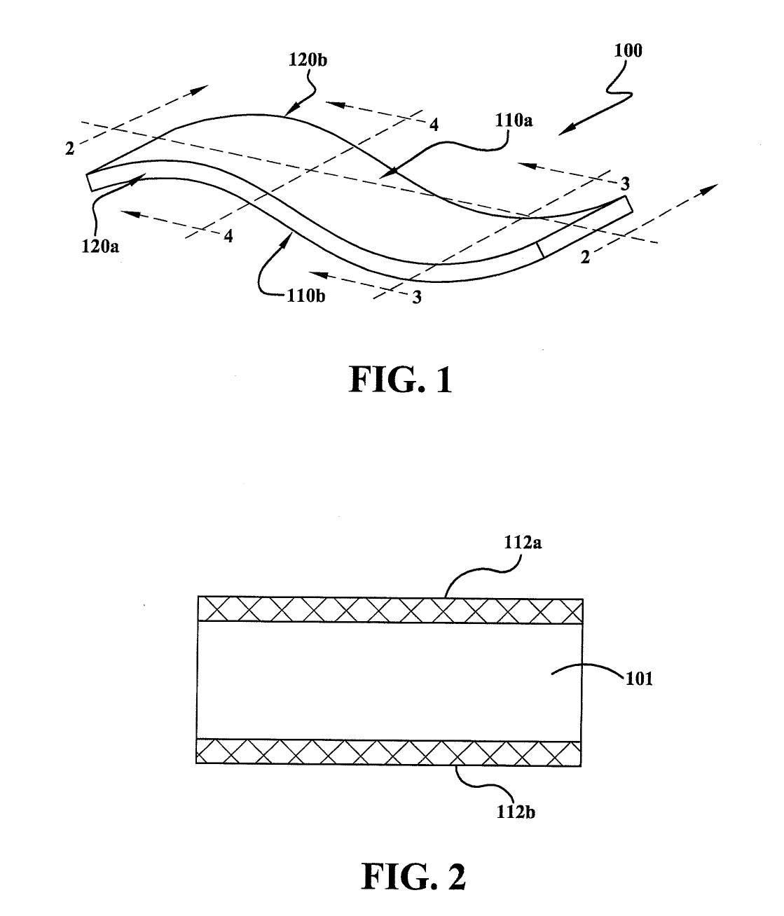

Referring now to the drawings wherein the showings are for purposes of illustrating embodiments of the invention only and not for purposes of limiting the same, FIG. 1 is a drawing of an arbitrary length of a tape 100 according to an embodiment. The tape 100 includes a tape member 101 made from a flexible sheet. The tape member 101 defines a first major surface 110a and a second major surface 110b generally parallel to the first major surface 110a. The first and second major surfaces 110a, 110b are shown spaced apart, and the space between them is shown bounded by a first minor surface 120a and a second minor surface 120b, which together adjoin the major surfaces 110a, 110b.

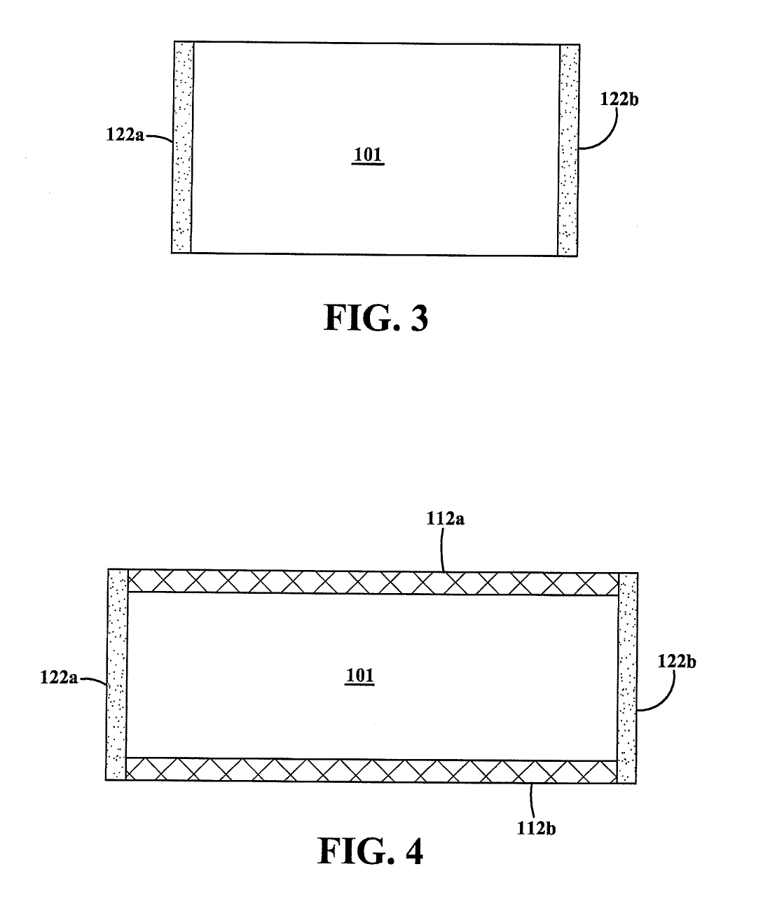

According to FIG. 2, a cross section of the embodiment shown in FIG. 1 includes a first adhesive layer 112a and a second adhesive layer 112b both being adhesively bonded to opposing faces 110a, 110b of the tape member 101. According to FIG. 3, another cross section of the embodiment shown in FIG. 1 includes a first hydrophobic moisture barrier 122a and a second hydrophobic moisture barrier 122b affixed to opposing minor surfaces 120a, 120b of the tape member 101. According to FIG. 4, yet another cross section of the embodiment shown in FIG. 1 includes the first adhesive layer 112a adhesively affixed to the first major surface 110a of the tape member 101, and the second adhesive layer 112b similarly affixed to the second major surface 110b of the tape member 101. Additionally, FIG. 4 shows the first hydrophobic moisture barrier 122a affixed to the first minor surface 120a of the tape member 101, and the second hydrophobic moisture barrier 122b affixed to the second minor surface 120b of the tape member 101. As shown in FIG. 4, the adhesive layers 112a, 112b are bounded by the hydrophobic moisture barriers 122a, 122b, which protect the adhesive layers 112a, 112b from atmospheric moisture.

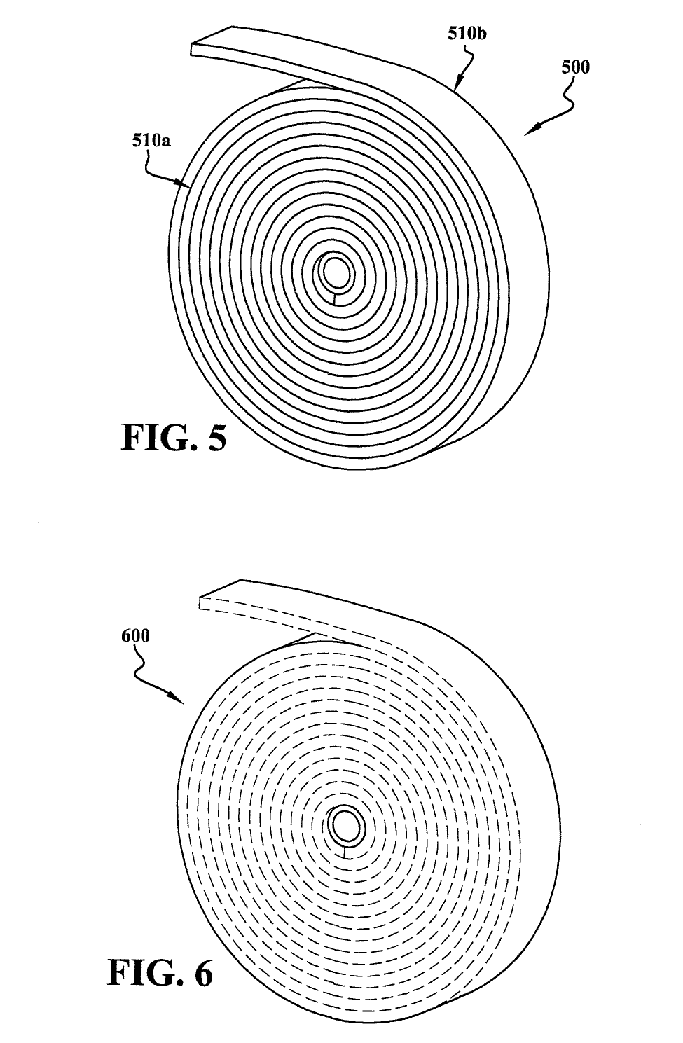

FIG. 5 shows a foam tape system according to an embodiment configured in a roll 500. The roll 500 defines a first face 510a and a second face 510b, which comprise the minor surfaces 120a, 120b of the tape member 101 configured in a spiral arrangement. Thus, the minor surfaces, 120a, 120b collectively define the faces 510a and 510b of the roll. According to FIG. 6, an embodiment includes a hydrophobic moisture barrier 600 disposed on both faces 510a, 510b of the roll 500. The hydrophobic moisture barrier 600 is a collective representation of the hydrophobic moisture barrier 122a and/or 122b, arranged in a spiral configuration to define a face. As the tape system is unrolled, the hydrophobic moisture barrier 600 remains bonded to the sides 120a, 120b of the tape member 101, and is more specifically denoted with reference numbers 122a, 122b on unrolled portions of the tape.

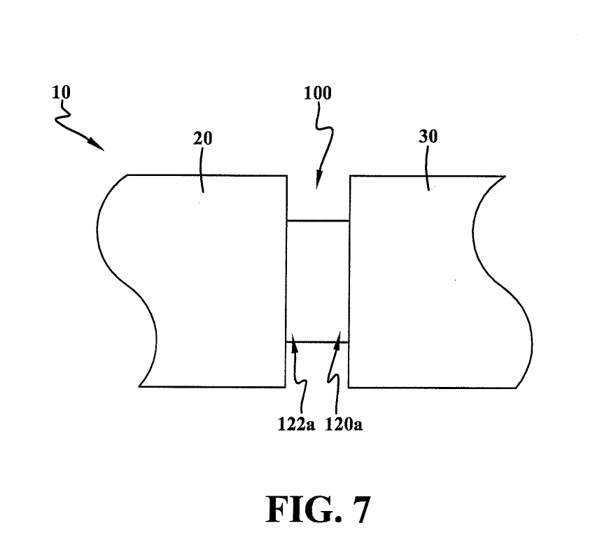

FIG. 7 shows a vehicle show a vehicle 10 that may be equipped with the tape 100 according to one embodiment of this invention. It is to be understood that the tape 100 of this invention will work with any vehicle including, for some non-limiting examples, cars, vans, trucks, sports utility vehicle (SUV), crossover vehicles, airplanes, and boats. The vehicle 10 may include a first vehicle component 20 and a second vehicle component 30. In one embodiment, the tape 100 may attach the second vehicle component 30 to the first vehicle component 20. When the tape 100 is installed on the vehicle 10, the hydrophobic moisture barriers 122a, 122b can protect the tape 100 from atmospheric moisture. One or more of the first vehicle component 20 and the second vehicle component 30 can be a vehicle exterior component.

The embodiments have been described, hereinabove. It will be apparent to those skilled in the art that the above methods and apparatuses may incorporate changes and modifications without departing from the general scope of this invention. It is intended to include all such modifications and alterations insofar as they come within the scope of the appended claims or the equivalents thereof.

Having thus described the invention, it is now claimed:

1. A moisture resistant tape system, comprising:
a tape member comprising a flexible sheet having a first major surface and a second major surface generally parallel to the first major surface, the first major surface and second major surface being spaced apart, the space bounded by a first minor surface and a second minor surface adjoining the first and second major surfaces, and the tape member further comprising a foamed polymer composition; and
a side layer comprising a hydrophobic moisture barrier fixedly disposed on the first minor surface of the tape member.

2. The tape system of claim 1, further comprising:
a second side layer comprising a hydrophobic moisture barrier fixedly disposed on the second minor surface of the tape member.

3. The tape system of claim 1, further comprising at least a first adhesive layer adhesively disposed on a major surface of the tape member.

4. The tape system of claim 3, wherein a first adhesive layer is adhesively disposed on the first major surface and a second adhesive layer is adhesively disposed on the second major surface of the tape member.

5. The tape system of claim 1, wherein the side layer comprises a hydrophobic organic polymer selected from one or more of polyfluoroethylene, polytetrafluoroethylene, polyperfluoroolefin, polyethylene, and polyolefin.

6. A process for producing side-coated tape, comprising the steps of:
providing a roll of an adhesive foam tape, the roll defining a first side comprising a first minor face of a tape member arranged in a spiral configuration, and a second side comprising a second minor face of a tape member arranged in a spiral configuration;
applying a first moisture barrier to the first side of the roll, wherein the first moisture barrier bonds to the first minor face of the tape member, and wherein the first moisture barrier is adapted to allow the tape member to be unrolled while the first moisture barrier remains functionally bonded to the first minor face.

7. The process of claim 6, further comprising the step of:
applying a second moisture barrier to the second side of the roll, wherein the second moisture barrier bonds to the second minor face of the tape member, and wherein the second moisture barrier is adapted to allow the tape member to be unrolled while the second moisture barrier remains functionally bonded to the second minor face.

8. The process of claim 6, wherein the step of applying a moisture barrier to the first side of the roll further comprises applying a monomeric composition to the first side, and then curing the monomeric composition, the polymerized composition defining the functional moisture barrier.

9. The process of claim 7, wherein the steps of applying a moisture barrier to the first side of the roll and applying a moisture barrier to a second side of the roll further comprise applying a monomeric composition to the first and second sides, and then curing the monomeric composition, the polymerized composition defining the functional moisture barrier.

10. The process of claim 6, wherein the first moisture barrier is selected from one or more of polyfluoro olefin, polyfluoroethylene, polytetrafluoroethylene, polyperfluoro olefin, polyethylene, and polyolefin.

11. The process of claim 7, wherein the first moisture barrier and the second moisture barrier are independently selected from one or more of polyfluoro olefin, polyfluoroethylene, polytetrafluoroethylene, polyperfluoro olefin, polyethylene, and polyolefin.

12. The process of claim 6, wherein the step of applying a first moisture barrier to a first side of the roll comprises dip-coating the tape member in a polymerization reaction solution.

13. The process of claim 7, wherein the steps of applying a first and a second moisture barrier to a first and a second side of the roll comprises dip-coating the tape member in a polymerization reaction solution.

14. A vehicle comprising:
a first vehicle component; and
a moisture resistant tape comprising:
a tape member comprising a flexible sheet having a first major surface and a second major surface generally parallel to the first major surface, the first major surface and second major surface being spaced apart, the space bounded by a first minor surface and a second minor surface adjoining the first and second major surfaces, and the tape member further comprising a foamed polymer composition;
a first side layer comprising a hydrophobic moisture barrier fixedly disposed on the first minor surface of the tape member; and
a first adhesive layer adhesively disposed on the first major surface of the tape member;
wherein the first adhesive layer fixedly attaches the tape member to the first vehicle component.

15. The vehicle of claim 14 wherein the moisture resistant tape further comprises a second side layer comprising a hydrophobic moisture barrier fixedly disposed on the second minor surface of the tape member.

16. The vehicle of claim 14 further comprising:
a second vehicle component;
wherein the moisture resistant tape further comprises a second adhesive layer adhesively disposed on the second major surface of the tape member;
wherein the tape member fixedly attaches the second vehicle component to the first vehicle component.

17. The vehicle of claim 14, wherein the side layer comprises a hydrophobic organic polymer selected from one or more of polyfluoroethylene, polytetrafluoroethylene, polyperfluoroolefin, polyethylene, and polyolefin.
